(19) United States
(12) Patent Application Publication
(10) Pub. No.: US 2026/0270572 A1
(43) Pub. Date: Sep. 10, 2026

(54) EVENT DETECTION CIRCUITRY, EVENT DETECTION SENSOR, EVENT DETECTION METHOD

(71) Applicant: Sony Semiconductor Solutions Corporation, Kanagawa (JP)

(72) Inventors: Daniel VAN NIEUWENHOVE, Basingstoke (GB); Maarten KUIJK, Basingstoke (GB)

(73) Assignee: Sony Semiconductor Solutions Corporation, Kanagawa (JP)

(21) Appl. No.: 19/164,594

(22) PCT Filed: Mar. 28, 2024
(86) PCT No.: PCT/EP2024/058450

§ 371 Date: Sep. 12, 2025

(30) Foreign Application Priority Data
Mar. 31, 2023 (EP) 23165793.3

(51) Int. Cl. H04N 25/47; G01S 7/4863; G01S 7/4865; H04N 25/773

(52) U.S. Cl. CPC H04N 25/47; G01S 7/4863; G01S 7/4865; H04N 25/773

(57) ABSTRACT

The present disclosure generally pertains to event detection circuitry configured to: obtain a photon detection signal, which is indicative of a photon being incident on a photo detection unit; associate the photon detection signal with a photon detection time period; and detect an event if, within a predetermined integration time period, a difference is detected between a number of associations of the photon detection signal with a photon detection time period and a number of associations of a previous event.

### TECHNICAL FIELD

The present disclosure generally pertains to event detection circuitry, an event detection sensor, and an event detection method.

### TECHNICAL BACKGROUND

Generally, time-of-flight technology is known. For example, in SPAD (single photon avalanche diode) based time-of-flight (ToF), one may measure a time of a roundtrip delay of emitted light in order to determine a distance to a scene or to obtain a depth image of the scene, or the like.

Event sensing (e.g., based on a dynamic vision sensor (DVS)) may be used to determine events in the scene, i.e., in order to determine whether the scene changes.

When combining these two technologies, it is known to provide a hybrid sensor, i.e., a sensor which has ToF pixels and DVS pixels which either may be arranged in a predetermined pattern. Another way of combining the two technologies may be to provide two single sensors which may be calibrated with respect to their positions (i.e., such that they have the same field of view).

Although there exist techniques for obtaining a ToF measurement and for event sensing, it is generally desirable to provide event detection circuitry, an event detection sensor, and an event detection method.

### SUMMARY

According to a first aspect, the disclosure provides event detection circuitry configured to:
obtain a photon detection signal, which is indicative of a photon being incident on a photo detection unit;
associate the photon detection signal with a photon detection time period; and
detect an event if, within a predetermined integration time period, a predetermined difference is detected between a number of associations of the photon detection signal with a photon detection time period and a number of associations of a previous event.

According to a second aspect, the disclosure provides an event detection sensor comprising:
a plurality of photo detection units arranged in an array; and
event detection circuitry configured to:
obtain, for the plurality of photo detection units, a photon detection signal, which is indicative of a photon being incident on a photo detection unit of the plurality of photo detection units;
associate the photon detection signal with a photon detection time period; and
detect an event for at least one photo detection unit of the plurality of photo detection units, if, within a predetermined integration time period, a predetermined difference is detected between a number of associations of the photon detection signal with a photon detection time period and a number of associations of a previous event.

According to a third aspect, the disclosure provides an event detection method for operating event detection circuitry, the method comprising:
obtaining a photon detection signal, which is indicative of a photon being incident on a photo detection unit;
associating the photon detection signal with a photon detection time period; and
detecting an event if, within a predetermined integration time period, a predetermined difference is detected between a number of associations of the photon detection signal with a photon detection time period and a number of associations of a previous event.

Further aspects are set forth in the dependent claims, the following description, and the drawings.

### BRIEF DESCRIPTION OF THE DRAWINGS

Embodiments are explained by way of example with respect to the accompanying drawings, in which:

FIG. 1 depicts an embodiment of pixel circuitry including event detection circuitry according to the present disclosure using a digital time count signal;

FIG. 2 depicts a more detailed view on the event detection circuitry depicted in FIG. 1;

FIG. 3 depicts an embodiment of pixel circuitry including event detection circuitry according to the present disclosure using an analog time count signal;

FIG. 4 depicts an embodiment of a signal evolution using information to optimize power;

FIG. 5 depicts a timing diagram of a system that is operated in a high light level condition;

FIG. 6 depicts a further embodiment of pixel circuitry using a digital time count signal, wherein also a photon number is used in the event detection circuitry;

FIG. 7 depicts a flow chart of an event detection method according to the present disclosure;

FIG. 8 depicts a flow chart of an imaging method according to the present disclosure;

FIG. 9 depicts a timing diagram for illustrating sensing modes according to the present disclosure and their time consumption;

FIG. 10 depicts a schematic diagram of a macropixel according to the present disclosure that can perform a TOF measurement;

FIG. 11 depicts two hybrid sensors which include pixels for TOF, imaging and/or EVS wherein the pixels are arranged in different pattern in the respective sensor;

FIG. 12 depicts an embodiment of an event detection method according to the present disclosure; and FIG. 13 depicts a further embodiment of an event detection method according to the present disclosure in which, after event detection, time-of-flight imaging is carried out.

### DETAILED DESCRIPTION OF EMBODIMENTS

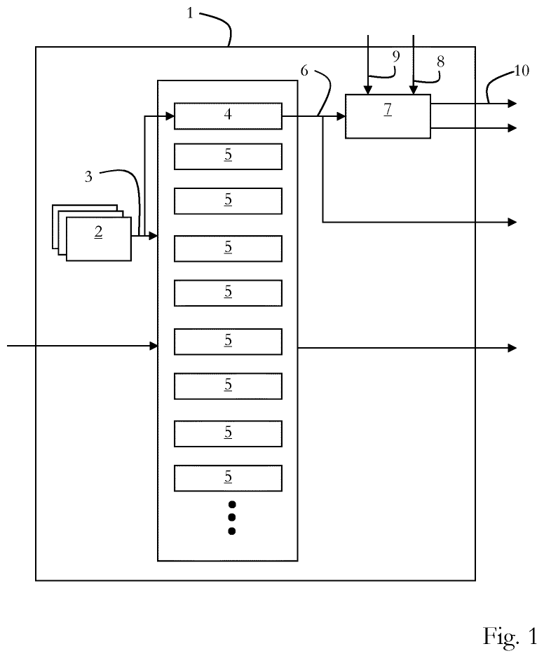

Before a detailed description of the embodiments starting with FIG. 1 is given, general explanations are made.

As mentioned in the outset, time-of-flight (ToF) technology and event sensing technology are generally known. However, it has been recognized that it may be desirable to provide the different functionalities of the two technologies based on the same pixel structure. Moreover, it has been recognized that it may be desirable to provide further functionalities in the same sensor.

It has been recognized that photon detection/counting technology, e.g., based on SPADs, may also be used for event sensing before using it for time-of-flight, for example.

Therefore, some embodiments pertain to event detection circuitry configured to: obtain a photon detection signal, which is indicative of a photon being incident on a photo detection unit; associate the photon detection signal with a photon detection time period; and detect an event if, within a predetermined integration time period, a predetermined difference is detected between a number of associations of the photon detection signal with a photon detection time period and a number of associations of a previous event.

The circuitry may be based on any entity or multitude of entities which are configurable for processing signals originating from a photo detection unit (e.g., a photo sensor, pixel, or the like), such as one or multiple processor(s) (e.g., CPU (central processing unit), GPU (graphics processing unit)), an FPGA (field-programmable gate array), or the like, wherein also combinations of different entities may be envisaged according to the present disclosure.

In some embodiments, a photon detection signal is obtained which may be indicative of a photon (i.e., one or more photons) being incident on a photo detection unit. That means, the photon detection signal may derive from the photo detection unit directly or it may be processed first before it is obtained by the circuitry. In some embodiments, the photo detection unit may be included in the event detection circuitry, whereas in other embodiments, the event detection circuitry and the photo detection unit may be separate elements.

The photo detection unit may be based on any technology which is suitable for detecting (single) photons (or for determining a number of incident photons in general), such as a SPAD (single photon avalanche diode), JOT pixel (tiny pixel with low noise) an APD (avalanche photodiode), a regular photodiode, or the like.

In some embodiments, the photon detection signal may be associated with a photon detection time period (e.g., a point of time or a time interval in which the detection has taken place). For example, an event may be triggered when a predetermined number of photons has been incident on the photo detection unit.

A photon detection time period may correspond to a predetermined time within an integration time period during which photon detection signals may be summed up, when the number of detected photons during the predetermined integration time period exceeds a predetermined threshold, an event is detected.

The predetermined threshold may correspond to a difference between a number of associations of the photon detection signal with a photon detection time period and a number of associations of a previous event.

In a non-limiting example, a memory holds a previous measurement of ten photons, an event is generated when less or more than ten photons have been incident on the photo detection unit within a predetermined integration time (e.g., a frame). Hence, every time a photon avalanche is generated (in the case of a SPAD), it may be indicative of a photon being incident on the SPAD. Hence, the avalanche signal may be processed and thereby associated with a photon detection time period (e.g., as in CADTOF, as will be discussed below). For example, when such a process is carried out more a predetermined amount of times within a given predetermined integration time, an event may be detected.

Hence, according to the present disclosure, a SPAD based event detection circuit may be provided. In contrast to known event detection devices, which require analog change detection typically noisy or with slow response in low light conditions. Further, for example, event detection and imaging may be carried out by the same device. For example, after an event has been detected, imaging may be carried out afterwards.

In some embodiments, event detection circuitry may be further configured to: generate an event detection signal upon detection of the event. For example, the signal may be used for initiating an imaging phase the photo detection unit.

In some embodiments, the event detection circuitry is further configured to: obtain, with the photo detection unit, a time-of-flight measurement (for example, upon detection of the event), as discussed herein.

In some embodiments, the photo detection unit includes a single photon avalanche diode, as discussed herein.

In some embodiments, the circuitry includes at least two accumulators which are optimized for different frame rates.

In some embodiments, an event is detected based on a comparison of respective output signals of the at least two accumulators.

In some embodiments, the circuitry is further configured to: select one output signal of the respective output signals of the at least two accumulators based on the comparison.

In some embodiments, the output frame rate corresponds to a lower frame rate of the at least two accumulators, if no event is detected, and wherein the output frame rate corresponds to a higher frame rate of the at least two accumulators if an event is detected.

Some embodiments pertain to an event detection sensor including: a plurality of photo detection units arranged in an array; and event detection circuitry configured to: obtain, for the plurality of photo detection units, a photon detection signal, which is indicative of a photon being incident on a photo detection unit of the plurality of photo detection units; associate the photon detection signal with a photon detection time period; and detect an event for at least one photo detection unit of the plurality of photo detection units, if, within a predetermined integration time period, a predetermined difference is detected between a number of associations of the photon detection signal with a photon detection time period and a number of associations of a previous event, as discussed herein.

In some embodiments, the event detection sensor further includes a data path configured to only transmit a signal of photo detection units for which an event is determined.

Generally, the event detection sensor may include or may be associated with event detection circuitry, as described herein, and a repetitive description is omitted. However, it should be understood that all aspects described for the event detection circuitry accordingly apply to the event detection sensor.

The plurality of photo detection units arranged in an array may constitute an image sensor, as it is generally known. Moreover, some of the plurality of photo detection units may be used as event detectors and some may be used as ToF imagers, thereby using the sensor as a hybrid sensor.

Hence, according to the present disclosure, a combination of event sensing, viewing, PCT, and ToF may be carried out without the need of a hybrid sensor (i.e., a sensor with different photo detection elements). Moreover, a high resolution may be achieved, while at the same time, a power consumption may be reduced compared to traditional ToF sensors since a ToF measurement may only be triggered in the case of an event. Furthermore, noise may be decreased.

The event may be triggered isolated for each photo detection unit, or if one photo detection unit detects an event, the event may be triggered for all or a subset of photo detection unit, or at least some photo detection units may need to detect an event in order to detect the event.

In some embodiments, each of the plurality of photo detection units is a single photon avalanche diode, as discussed herein.

In some embodiments, the event detection sensor is further configured to: obtain, with the plurality of photo detection units, a time-of-flight measurement upon detection of the event, as discussed herein.

In some embodiments, at least two different phase delayed modulation signals are applied as analog time code to the plurality of photo detection units for obtaining a time-of-flight measurement with at least one photo detection unit of the plurality of photo detection units (e.g., upon detection of the event).

For example, a zero degree phase signal may be applied to the first subset and a ninety degrees phase signal may be applied to the first subset, such that the measurement may be carried out. Such a technology may be known as CADToF, as described in patent application WO 2022043480 A1, which is hereby incorporated.

It should be noted that the event detection according to the present disclosure has the additional effect that it is compatible with the CADToF technology, as described above, and especially as CADToF derives from similar in-pixel functionalities and circuits,

Generally, it should be understood that the CADToF technology may be applicable to the present disclosure as a whole, or, that the principles of the present disclosure may be applied within a CADToF system.

Some embodiments pertain to an event detection method (for operating an event detection sensor including event detection circuitry), the method including: obtaining a photon detection signal, which is indicative of a photon being incident on a photo detection unit; associating the photon detection signal with a photon detection time period; and detecting an event if, within a predetermined integration time period, a predetermined difference is detected between a number of associations of the photon detection signal with a photon detection time period and a number of associations of a previous event, as discussed herein.

In some embodiments, the method further includes: generating an event detection signal upon detection of the event, as discussed herein. In some embodiments, the method further includes: obtaining, with the photo detection unit, a time-of-flight measurement, as discussed herein. In some embodiments, the photo detection unit includes a single photon avalanche diode, as discussed herein. In some embodiments, event detection circuitry includes a plurality of photo detection units arranged in an array, wherein an event is detected if the difference is detected for at least one photo detection unit of the plurality of photo detection units, as discussed herein. In some embodiments, the method further includes obtaining, with the plurality of photo detection units, a time-of-flight measurement upon detection of the event, as discussed herein. In some embodiments, at least two different phase delayed modulation signals are applied as analog time code to the plurality of photo detection units for obtaining a time-of-flight measurement with at least one photo detection unit of the plurality of photo detection units, as discussed herein. In some embodiments, the circuitry includes at least two different accumulators which are optimized for different frame rates, as discussed herein. In some embodiments, an event is detected based on a comparison of respective output signals of the at least two accumulators, as discussed herein. In some embodiments, the method further includes: selecting one output signal of the respective output signals of the at least two accumulators based on the comparison. In some embodiments, the output frame rate corresponds to a lower frame rate of the at least two accumulators, if no event is detected, and wherein the output frame rate corresponds to a higher frame rate of the at least two accumulators if an event is detected.

Some embodiments pertain to an image sensor based on a SPAD-pixel array unit including: a time-code generation unit configured to generate a time code (Tc) which is initialized at a start timing of an exposure period; wherein each pixel includes a counting unit configured to count SPAD output pulses within an exposure period and to output a counted value; wherein each pixel further includes an acquiring unit configured to acquire the time code indicating a time at which the counted value reaches a threshold before the exposure period elapses; wherein the acquiring unit is configured to output a digital or analog signal representative of a photon count.

In some embodiments, the digital signal is acquired by extrapolating the photon count over a whole exposure period.

In some embodiments, the sensor is further configured for at least one of event-based sensing (EVS), photon counting (PCT), time-of-flight sensing (TOF), direct time-of-flight sensing (DTOF), traditional imaging (CIS).

In some embodiments, each pixel further includes a (e.g., 14-bit) memory configured to store a previous time code (Tc-1) or the digital signal representative a previous photon count (Cph-1) recorded for a previous exposure period.

In some embodiments, each pixel further includes a comparator configured to compare Tc-1 or Cph-1 stored in the (14-bit) memory with Tc or Cph acquired during the current exposure period.

In some embodiments, the comparator is further configured to compare the most active stored bit and one bit higher and a bit lower (+/−1 bit) between Tc and Tc-1 or Cph and Cph-1. Based on the result of the comparison, the comparator is, in some embodiments, further configured to output a signal indicative of the occurrence of an event/no event in the observed scene.

In some embodiments, the counting unit is a switching capacitor (switchcap).

In some embodiments, the switching capacitors are configured as a CADToF circuit.

In some embodiments, the counting unit is a digital counter or an analog counter.

In some embodiments, the sensor is based on macropixels of sixteen times sixteen SPAD pixels in order to share two-hundred-fifty-six counters and to output a dToF signal based on histogramming.

In some embodiments, each pixel includes an analog comparator configured to shift a dynamic range of the sensor based on a predefined threshold of detected light events by instructing the acquiring unit to either output Te or Cph.

In some embodiments, the sensor further includes a color filter array patterned with 50% all-pass (for imaging/event sensing) and 50% band pass (940 nm) (for dToF/PCT).

The methods as described herein are also implemented, in some embodiments, as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, there is depicted pixel circuitry 1 including event detection circuitry according to the present disclosure.

The pixel circuitry 1 includes a plurality (or one or more, in some embodiments, as should generally be understood for every embodiment of the present disclosure) of SPADs 2 which, when light is incident on a SPAD 2, generate an avalanche signal 3, which is fed into a block having one or more counters 5. At least one counter 3 is set to a predetermined counting threshold which corresponds to a number of photons which are counted. When the threshold is exceeded, an overflow signal 6 is generated and fed into an event comparator/latch circuitry 7. The event comparator/latch circuitry 7 further receives a digital time count signal 8 and, if necessary, an event flag reset signal 9 (in case an event should be reset and an event comparison/counting should be restarted).

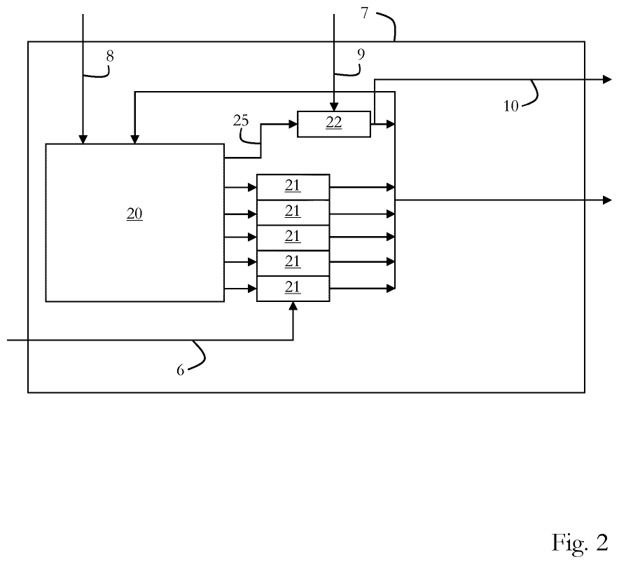

The event comparator/latch circuitry 7 will now be further described under reference of FIG. 2, in a block diagram.

The event comparator/latch circuitry 7 includes a combinatorial logic 20 in which the digital time count signal 8 and the digital memory elements 21 are compared with each other to detect change. At a predetermined point in time (e.g., at start-up or after resetting the event flag using reset signal 9), the current measurement is stored in the digital memory elements 21.

From then on, change detection according to the present disclosure can be done in many ways and the present disclosure should not be understood as being limited to one of the cases presented herein. For example, the digital time count 8 may provide linear or logarithmic counts and combinatorial logic 20 may be configured to take an absolute difference with the digital memory elements 21 and detect change by checking if such absolute difference is bigger than a given event threshold. In another embodiment, the digital time count 8 may be a one bit rotating signal, and combinatorial logic 20 could be configured to detect change by checking a position delta being more than two bit positions between the stored value in 21 and the instant value 8.

If change is detected by the combinatorial logic 20, it is stored in a logic element 22.

The logic element 22 is configured to output the event flag signal 10, thereby indicating the pixel has detected change. At fixed intervals, such a change signal 10 can be read-out from the outside, allowing to change settings of the sensor to acquire more frames after such change detection, or the like. Once the change detection was read, it is reset through signal 9 to be ready for detecting a next change.

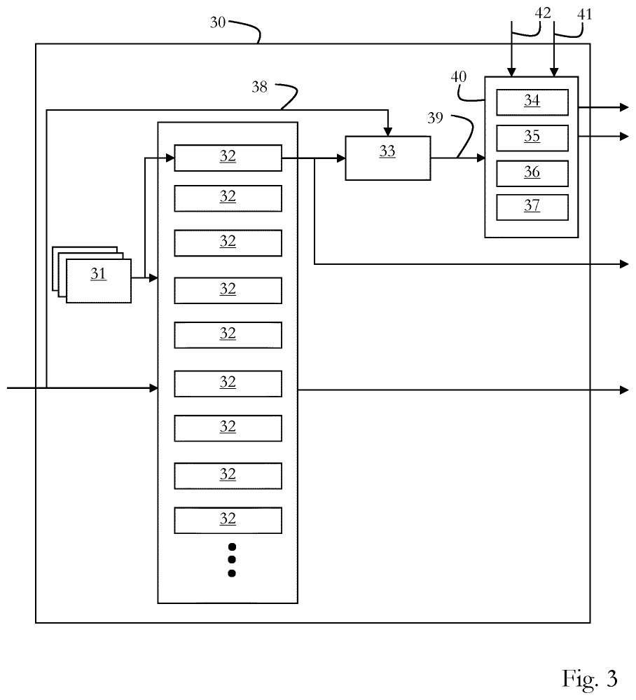

FIG. 3 depicts pixel circuitry 30 according to the present disclosure. Similar to FIG. 1, a plurality (or one or more, in some embodiments, as already stated above) of SPADs 31 are shown, but in this embodiment, an analog counter is used and at least one is fed into a comparator 33. It is to be noted that the SPADs 31 and analog counters 32 could also be implemented as one or more regular photodiodes with a 4T (or other) readout circuit. Such a circuit indeed has a changing analog voltage proportionate to the amount of incoming photons, however, the SPAD implementation is currently considered more sensitive and lower noise. The comparator 33 receives an external threshold signal 38 and, if a threshold which is indicated by the external threshold signal is exceeded, the comparator 33 outputs an overflow signal 39, which is fed into event comparator/latch circuitry 40. In contrast to the event comparator/latch circuitry 7, the event comparator/latch circuitry 40 receives an analog time count signal 41 (and not a digital signal). The analog time count signal 41 is changing proportionately over the targeted exposure time, with a linear (or logarithmic, in some embodiments) voltage versus time relation.

Furthermore, the event comparator/latch circuitry 40 receives an event flag reset signal 42.

The event comparator/latch circuitry 40 includes accumulators 34 to 37 which are driven such that their output is optimized for different frames rates.

The optimization may be achieved, in some embodiments, by ensuring that the circuit has converged within a frame rate period. For example, for an output of 1000 fps, if the accumulator is an analog memory such as a sample and hold, it may be achieved by sampling at least once every millisecond, or, if the accumulator is an averaging switchcap circuit with a capacitor ratio of N, the circuit may have an approximated time constant N and optimization may be achieved by taking at least five times N samples each millisecond with the switchcap in order to converge within the 1000 fps frame period of one millisecond.

Different circuits and framerates may be optimized accordingly, each time assuring convergence of the output signal is obtained within the frame rate period.

It should be understood that a lower/higher number of accumulators can be implemented as well according to the circumstances, and instead of or next to different frame rates other parameters could be different as well, such as integration time or counter threshold.

In some embodiments, an accumulator is any analog memory or other analog storage means such as an averaging switched capacitor circuit. Hereinafter, the latter case is discussed for illustrational purposes. Based on overflow signal 39, such a circuit will switch its small capacitor pre-charged with a sample of the analog code 41 and discharge it to its bigger capacitor. Hence, at every overflow signal 39, the analog time count signal 41 is added 1/N times smaller onto the bigger capacitor, wherein N is the ratio of the sum of the switchcap big and small capacitor and the small sampling capacitor. This creates an exponential moving average function of the analog code 41.

Accumulator 37 was designed with a very big ratio N for the lowest frame rate (in this embodiment 5 frames per second (fps)) and accumulator 34 with the smallest ratio for the highest frame rate (in this embodiment 1000 fps). Accumulators 35 and 36 are designed in-between for 50 fps and 200 fps, in this embodiment, wherein the particular frame rates shall not be considered as binding. For example, accumulators 34 to 37 may be provided individually, e.g., they may be built as a sequence of four switchcaps (switching capacitors) with smaller ratio N, wherein 34 only uses the first stage, 35 is the combination of the first two, 36 is the combination of the first three, and 37 is the combination of all four, yielding the highest accumulated ratio N.

Based on these four accumulators, change detection can be realized. In this case, when placing a comparator (e.g., a Schmitt trigger) over the output of accumulator 34 and the output of accumulator 35, this comparator changes output when there is a sudden signal change, since accumulator 34 will change faster than accumulator 35. Therefore, this signal indicates change at 1000 fps not yet seen at 200fps. A change detection flag may be obtained by maintaining the high or low peak of such comparator output.

As discussed above, such change flag may alternatively be read-out from the outside, and reset once action or notion has been taken. Similarly, comparators may be implemented between the other accumulators 35, 36 and 37 enabling change detection at the lower framerates, as well. Based on such signals, an output selector switch may be added that chooses the current valid signal. If, for example, there was no change between 1000 fps and 200 fps, and no change between 200 fps and 50 fps, yet the comparator between 50 fps and 5 fps indicates a significant difference, the 5 fps signal may be unreliable and changing still, and the output selector would select the 50 fps as the best output for the pixel. After a while, once the 5 fps has also reached close to the 50 fps stable signal amplitude, the comparator between 50 and 5 fps will indicate no more difference and output selector can automatically choose the more averaged 5 fps value as output.

One way to read-out such a signal, in some embodiments, is using a bus per row for the change flags per category. If one pixel highlights a change, the pixel puts the bus to high, and a scan of the row is carried out at the next possible moment. Pixels highlighting changes are converted to digital with an ADC and read-out. Depending on the speed of change, less or more bits could be used. For example, 4 bits for 1000 fps, allowing higher conversion speeds, and 10 bits for 5 fps being more precise yet taking more time, and this to optimize the conversion time for the array. In this way a synchronous scan for changes, e.g., at 1000 fps may be implemented, while the pixels continuously keep asynchronous 5 fps to 1000 fps averaged version of the measured signal stored, that are read-out depending on the changes in the scene.

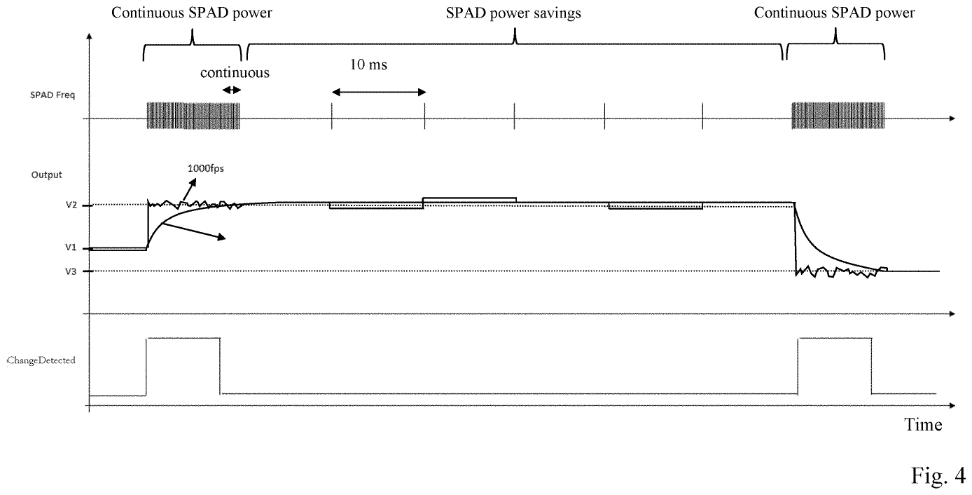

FIG. 4 depicts an embodiment of a signal evolution using above information to optimize power of the system based on the 50 fps and 1000 fps signals. For example, if a target framerate of 50 fps is wanted, whenever a comparator between 50 fps and 1000 fps indicates no change has happened, the system internal frame rate could be reduced whereby only once every ten milliseconds, an overflow measurement is obtained and compared to the existing stored averages in the pixel. Hence requiring only once every ten milliseconds the needed SPAD events (e.g., 200) and associated power to create the overflow measurement.

As soon as a change is detected, the system may go back to faster data acquisition and put the circuit in continuous acquisition at its normal internal framerate (e.g., every two milliseconds, or even faster every 200 μs or 20μs depending on the implementation) until convergence between 50 fps and 1000 fps is obtained, where it can again switch to one overflow per ten milliseconds. This results in two measurement per 50 fps frame of twenty milliseconds, hereby allowing half of that time for converging the 50 fps output value (e.g., in a situation where change is detected only ten milliseconds after it happened).

This method may allow for significant SPAD power savings, whilst maintaining a 50 fps read-out speed at the output.

Another effect of these change indicators between the obtained measurements at different frame rates is that it would allow to reduce the output bandwidth of the image sensor. This could be done by only outputting the changed pixels. On the host these can be re-assembled into full pictures based on the full set of changed images. In case change is limited in the image, the sensing framerate can be significantly increased to e.g., 1000 or even 10000 fps without requiring more ADC conversions and/or high output stage bandwidth. Of course, if needed a full image can be requested and transferred as well.

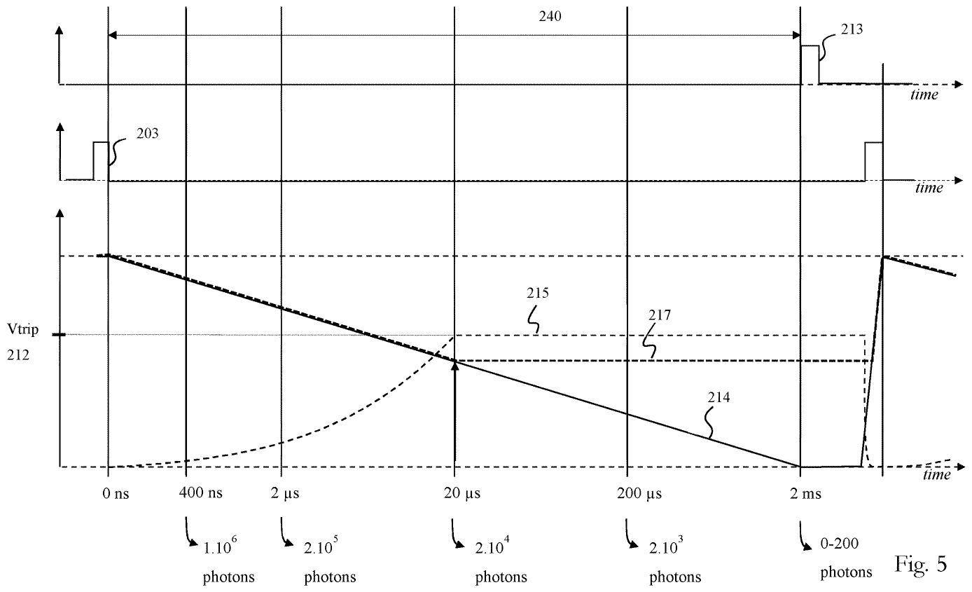

FIG. 5 shows an example of a logarithmic voltage versus time analog time count signal 214. In the graph shown a high light level condition was assumed, i.e., of 20000 photons in a same length period 240 of two milliseconds. In this embodiment, the curve LowLL 215, corresponding to the internal analog counter, increases hundred times faster compared to when 200 photons would be incident in the frame. Instead of two milliseconds, it only takes 20 μs to reach threshold Vtrip 212. At the 20 μs moment, Vtrip 212 is reached by LowLL 215, and the voltage on curve HighLL 217 is fixed and kept on an analog memory. As described above, such an accumulator may additionally or alternatively include or be based on a switchcap circuit.

At the end of the frame, this fixed voltage is read out on node HighLL 121, revealing the sampling moment, and thus the measured light level by only using 200 photons from the start of the period 240.

If the SPAD circuit is configured to disable after the threshold Vtrip was reached, the number of SPAD triggers will be limited to 200 under this high light level condition. Similarly, if the light level is very high, e.g., a million photons per two milliseconds, the max count of 200 photons may be reached already after 400 ns.

By distributing the analog time count signal 214 voltage in accordance with FIG. 5, starting at 1V, and ending at 0V for the full fame period 240, High Dynamic Range operation is supported. Assuming an accuracy of the ADC in the read-out circuit is 1 mV for 1 V (~10 bit), it may be achieved that over the full indicated high light level range of 200-1000000 photons, the 1-mV discretization may correspond to a variation of only 1% of incident light level variation.

A single frame will still have quite some show noise since each measurement is based on 200 photons only. The SNR is then 200 /\sqrt{200}=14.1 which gives a sigma of ~7% on the measured light level. If an application needs a better SNR, the maximum count may be increased, or it is possible to average out multiple frames by adding some additional circuitry, such as a switchcap accumulator. The subsequent low light level voltages on node LowLL 118 can be averaged, as well as the high light level values that get to node HighLL 121.

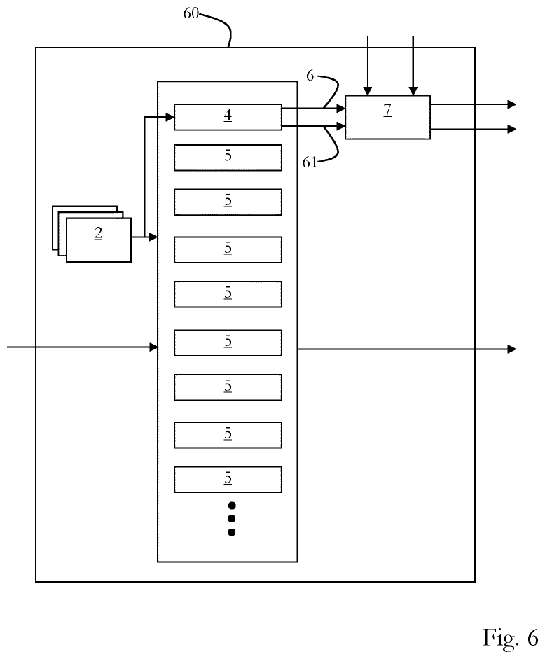

FIG. 6 depicts a further embodiment of pixel circuitry 7, which is similar to the embodiment of FIG. 3, but the difference is that, in addition to the overflow signal 6, a count signal 61 which is indicative of a photon number, is fed into the event comparator/latch circuitry 7.

In this case, instead of detecting a threshold overflowing with a comparator, at fixed intervals or exposure times, the count signal 61 is passed on to comparator/latch circuitry 7 and again exponentially averaged according to the different frame rates from 1000 fps to 5 fps. In this embodiment, minimum light intensity (to no light at all) may be needed to allow the overflow to be reached, and it also works if only one SPAD event was detected in the exposure time.

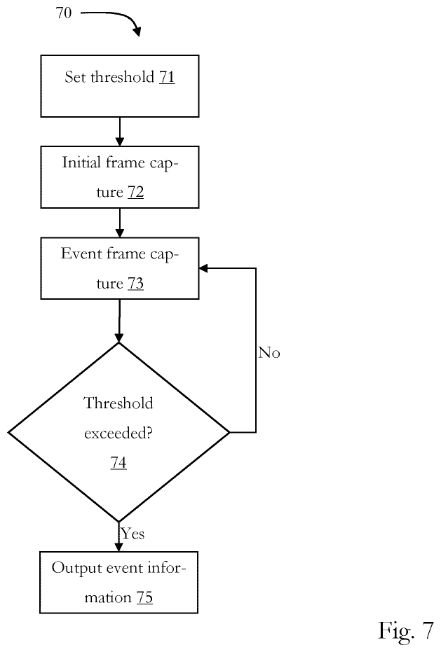

FIG. 7 depicts a flow chart of an event detection method 70 according to the present disclosure.

At 71, a threshold related to a number of photons is set, as described herein, which may be analog or digital.

At 72, an initiation frame is captured. In the initiation frame, a time code is measured for reaching the threshold, which is then stored in a memory.

At 73, an event frame is captured. If a change threshold versus the stored time code is exceeded, at 74, an event flag is generated and event information is output, and 75. If the time code/threshold is not exceeded, another event frame is captured.

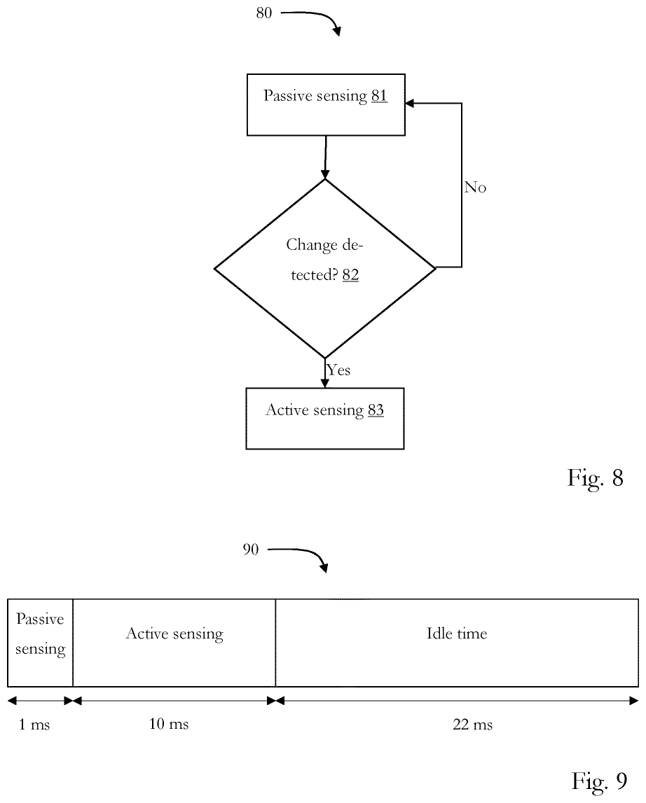

As indicated herein, the detection of the event may be a trigger for increasing the internal framerate or for taking a depth image, or the like, as indicated in FIG. 8, which is described in the following.

FIG. 8 depicts a flow chart of an imaging method according to the present disclosure.

At 81, passive sensing is carried out, i.e., event sensing, as described herein. In this embodiment, the event detection is carried out for detection a change in the scene. If no change is detected at 82, passive sensing 81 is further carried out. If a change is detected at 82, active sensing is carried out, i.e., a ToF measurement is carried out.

FIG. 9 depicts a timing diagram 90 for illustrating exemplary modes and their time consumption in an image sensor according to the present disclosure. Passive sensing, as described with respect to FIG. 9 takes one millisecond, in this embodiment. Active sensing (e.g., a time-of-flight measurement) takes ten milliseconds in this embodiment. After passive and active sensing, the sensor has an idle time of twenty-two milliseconds. Hence, a full frame takes thirty-three milliseconds, thus having roughly a frame rate of thirty fps.

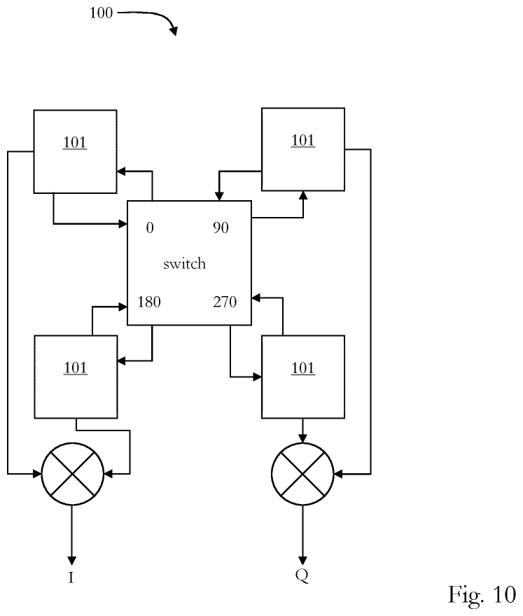

FIG. 10 depicts a schematic diagram of a macropixel 100 that can obtain a TOF measurement according to the present disclosure. The macropixel 100 includes four pixels 101 (wherein any number of pixels may be used), each pixel 101 including event sensing circuitry comprising switchcap circuits and a SPAD, as described herein. In this case, the analog time code used is a periodic modulation signal driven with different phase signals which are phase-shifted by ninety degrees with respect to each other. In case, an event is detected, active sensing is carried out, i.e., modulated light is emitted and detected with the pixels 101 based on the phase signals, as it is generally known in the field of time-of-flight, thereby obtaining I and Q values, as generally known. Thereby, the circuitry of each pixel is re-used to obtain a time-of-flight measurement in a macro-pixel configuration. This can for example be achieved when wiring the circuit in such a way so the SPAD signal can bypass analog counter 32 and comparator 33 and directly enter into accumulator 34 to 37, which may be connected to the periodic modulation signal analog time code with different phase signals which are phase-shifted by ninety degrees with respect to each other. The different periodic modulation signal analog time codes with different phase signals which are phase-shifted by ninety degrees with respect to each other can either be connected to multiple accumulators in one pixel or into accumulators spread over different pixels working together. Instead of phase shifts of ninety degrees other modulation signals can be used such as PRBS or phase shifts different than ninety degrees, as known by a person skilled in the art. The eventual achieved circuit is described in more detail in patent application WO 2022043480 A1, which is hereby incorporated.

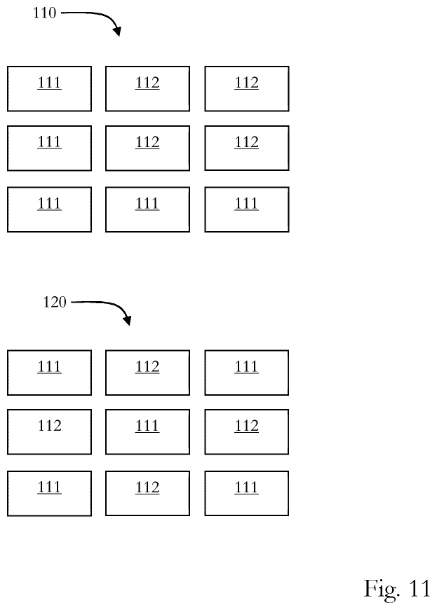

FIG. 11 depicts two hybrid sensors 110 and 120 which include pixels 111 including an all-pass filter for imaging/EVS and pixels 112 including a band-pass filter for ToF/imaging/EVS, wherein the pixels 112 further include event detection circuitry according to the present disclosure. That means, different types of passive sensing or passive and active sensing (after an event is detected) can be carried out at the same time.

The hybrid sensor 110 includes the pixels 112 in a group, such that they are next to each other, wherein the sensor 120 has a checkerboard pattern (every pixel 111 is next to a pixel 112).

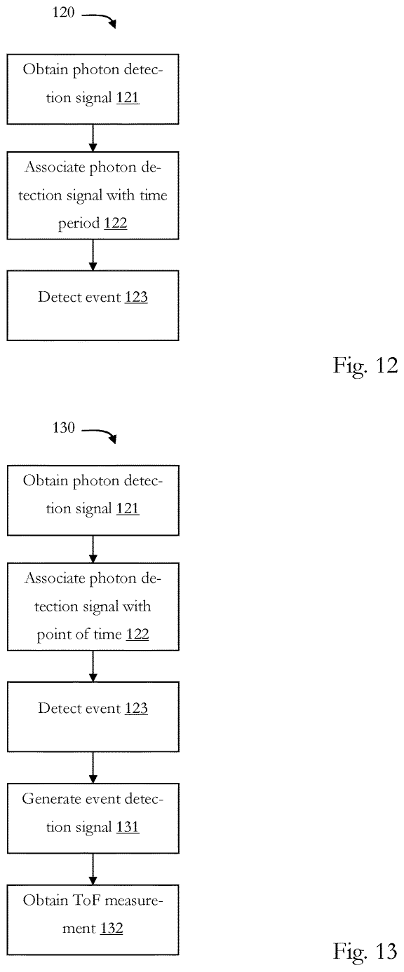

FIG. 12 depicts an event detection method 120 according to the present disclosure in a block diagram.

At 121, a photon detection signal is obtained, as discussed herein.

At 122, the photon detection signal is associated with a photon detection time period, as discussed herein.

At 123, an event is detected when the number of associations exceeds a threshold, as discussed herein.

FIG. 13 depicts an event detection method 130 according to the present disclosure in a block diagram, which is different from the method of FIG. 12 in that upon detection of the event, a ToF measurement is carried out.

At 121, a photon detection signal is obtained, as discussed herein.

At 122, the photon detection signal is associated with a photon detection time period, as discussed herein.

At 123, an event is detected when the number of associations exceeds a threshold, as discussed herein.

At 131, an event detection signal is generated, as discussed herein.

At 132, a ToF measurement is obtained, as discussed herein.

It should be recognized that the embodiments describe methods with an exemplary ordering of method steps. The specific ordering of method steps is however given for illustrative purposes only and should not be construed as binding. For example, the ordering of 71 and 72 in the embodiment of FIG. 7 may be exchanged. Other changes of the ordering of method steps may be apparent to the skilled person.

Please note that the division of the event sensing circuitry into units 20 to 22 or 34 to 43 is only made for illustration purposes and that the present disclosure is not limited to any specific division of functions in specific units. For instance, the control event sensing circuitry could be implemented by a respective programmed processor, field programmable gate array (FPGA), or the like.

In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) Event detection circuitry configured to:
   obtain a photon detection signal, which is indicative of a photon being incident on a photo detection unit;
   associate the photon detection signal with a photon detection time period; and
   detect an event if, within a predetermined integration time period, a predetermined difference is detected between a number of associations of the photon detection signal with a photon detection time period and a number of associations of a previous event.
(2) The event detection circuitry of (1), further configured to:
   generate an event detection signal upon detection of the event.
(3) The event detection circuitry of anyone of (1) or (2), further configured to:
   obtain, with the photo detection unit, a time-of-flight measurement upon detection of the event.
(4) The event detection circuitry of anyone of (1) to (3), wherein the photo detection unit includes a single photon avalanche diode.
(5) The event detection circuitry of anyone of (1) to (4), wherein the circuitry includes at least two accumulators which are optimized for different frame rates.
(6) The event detection circuitry of (5), wherein an event is detected based on a comparison of respective output signals of the at least two accumulators.
(7) The event detection circuitry of (6), wherein the circuitry is further configured to: select one output signal of the respective output signals of the at least two accumulators based on the comparison.
(8) The event detection circuitry of (7), wherein the output frame rate corresponds to a lower frame rate of the at least two accumulators, if no event is detected, and wherein the output frame rate corresponds to a higher frame rate of the at least two accumulators if an event is detected.
(9) An event detection sensor comprising:
   a plurality of photo detection units arranged in an array; and
   event detection circuitry configured to:
   obtain, for the plurality of photo detection units, a photon detection signal, which is indicative of a photon being incident on a photo detection unit of the plurality of photo detection units;
   associate the photon detection signal with a photon detection time period; and
   detect an event for at least one photo detection unit of the plurality of photo detection units, if, within a predetermined integration time period, a predetermined difference is detected between a number of associations of the photon detection signal with a photon detection time period and a number of associations of a previous event.
(10) The event detection sensor of (9), wherein each of the plurality of photo detection units is a single photon avalanche diode.
(11) The event detection sensor of (9) or (10), further comprising a data path configured to only transmit a signal of photo detection units for which an event is determined.
(12) The event detection sensor of anyone of (9) to (11), wherein at least two different phase delayed signals are applied as analog time code to the plurality of photo detection units for obtaining a time-of-flight measurement with at least one photo detection unit of the plurality of photo detection units.
(13) An event detection method for operating event detection circuitry, the method comprising:
   obtaining a photon detection signal, which is indicative of a photon being incident on a photo detection unit;
   associating the photon detection signal with a photon detection time period; and
   detecting an event if, within a predetermined integration time period, a predetermined difference is detected between a number of associations of the photon detection signal with a photon detection time period and a number of associations of a previous event.
(14) The method of (13), further comprising generating an event detection signal upon detection of the event.
(15) The method of (13) or (14), wherein the circuitry includes at least two accumulators which are optimized for different frame rates.
(16) The method of (15), wherein an event is detected based on a comparison of respective output signals of the at least two accumulators.
(17) The method of (16), further comprising: selecting one output signal of the respective output signals of the at least two accumulators based on the comparison.
(18) The method of (17), wherein the output frame rate corresponds to a lower frame rate of the at least two accumulators, if no event is detected, and wherein the output frame rate corresponds to a higher frame rate of the at least two accumulators if an event is detected.
(19) The method of anyone of (13) to (18), further comprising:

obtaining, with the photo detection unit, a time-of-flight measurement.
(20) The method of (13), wherein at least two different phase delayed modulations signals are applied as analog code to the plurality of photo detection units for obtaining a time-of-flight measurement with at least one photo detection unit of the plurality of photo detection units.
(21) A computer program comprising program code causing a computer to perform the method according to anyone of (12) to (20), when being carried out on a computer.
(22) A non-transitory computer-readable recording medium that stores therein a computer program product, which, when executed by a processor, causes the method according to anyone of (12) to (20) to be performed.

1. Event detection circuitry configured to:
obtain a photon detection signal, which is indicative of a photon being incident on a photo detection unit;
associate the photon detection signal with a photon detection time period; and
detect an event if, within a predetermined integration time period, a predetermined difference is detected between a number of associations of the photon detection signal with a photon detection time period and a number of associations of a previous event.

2. The event detection circuitry of claim 1, further configured to:
generate an event detection signal upon detection of the event.

3. The event detection circuitry of claim 1, further configured to:
obtain, with the photo detection unit, a time-of-flight measurement.

4. The event detection circuitry of claim 1, wherein the photo detection unit includes a single photon avalanche diode.

5. The event detection circuitry of claim 1, wherein the circuitry includes at least two accumulators which are optimized for different frame rates.

6. The event detection circuitry of claim 5, wherein an event is detected based on a comparison of respective output signals of the at least two accumulators.

7. The event detection circuitry of claim 6, further configured to:
select one output signal of the respective output signals of the at least two accumulators based on the comparison.

8. The event detection circuitry of claim 7, wherein the output frame rate corresponds to a lower frame rate of the at least two accumulators, if no event is detected, and wherein the output frame rate corresponds to a higher frame rate of the at least two accumulators if an event is detected.

9. An event detection sensor comprising:
a plurality of photo detection units arranged in an array; and
event detection circuitry configured to:
obtain, for the plurality of photo detection units, a photon detection signal, which is indicative of a photon being incident on a photo detection unit of the plurality of photo detection units;
associate the photon detection signal with a photon detection time period; and
detect an event for at least one photo detection unit of the plurality of photo detection units, if, within a predetermined integration time period, a predetermined difference is detected between a number of associations of the photon detection signal with a photon detection time period and a number of associations of a previous event.

10. The event detection sensor of claim 8, wherein each of the plurality of photo detection units is a single photon avalanche diode.

11. The event detection sensor of claim 9, further comprising a data path configured to only transmit a signal of photo detection units for which an event is determined.

12. The event detection sensor of claim 9, wherein at least two different phase delayed modulation signals are applied as analog time code to the plurality of photo detection units for obtaining a time-of-flight measurement with at least one photo detection unit of the plurality of photo detection units.

13. An event detection method for operating event detection circuitry, the method comprising:
obtaining a photon detection signal, which is indicative of a photon being incident on a photo detection unit;
associating the photon detection signal with a photon detection time period; and
detecting an event if, within a predetermined integration time period, a predetermined difference is detected between a number of associations of the photon detection signal with a photon detection time period and a number of associations of a previous event.

14. The method of claim 13, further comprising
generating an event detection signal upon detection of the event.

15. The method of claim 13, wherein the circuitry includes at least two accumulators which are optimized for different frame rates.

16. The method of claim 15, wherein an event is detected based on a comparison of respective output signals of the at least two accumulators.

17. The method of claim 16, further comprising:
selecting one output signal of the respective output signals of the at least two accumulators based on the comparison.

18. The method of claim 17, wherein the output frame rate corresponds to a lower frame rate of the at least two accumulators, if no event is detected, and wherein the output frame rate corresponds to a higher frame rate of the at least two accumulators if an event is detected.

19. The method of claim 13, further comprising:
obtaining, with the photo detection unit, a time-of-flight measurement.

20. The method of claim 13, wherein at least two different phase delayed modulation signals are applied as analog time code to the plurality of photo detection units for obtaining a time-of-flight measurement with at least one photo detection unit of the plurality of photo detection units.
